(19) United States
(12) Patent Application Publication
(10) Pub. No.: US 2025/0117797 A1
(43) Pub. Date: Apr. 10, 2025

(54) FRAUDULENT TRANSACTION MANAGEMENT

(71) Applicant: PAYPAL, INC., San Jose, CA (US)

(72) Inventors: Mingwei Ruan, Shanghai (CN); Chunliang Wu, Shanghai (CN); Linglin Niu, San Jose, CA (US); Lingyi Lu, Palo Alto, CA (US); Pablo Andres Cal, Tel Aviv (IL); Xuan Li, Shanghai (CN); Diya Luo, Shanghai (CN)

(21) Appl. No.: 18/293,755

(22) PCT Filed: Jan. 31, 2023
(86) PCT No.: PCT/CN2023/073999

§ 371 Date: Jan. 30, 2024

(51) Int. Cl. G06Q 20/40

(52) U.S. Cl. CPC G06Q 20/4016

(57) ABSTRACT

A method includes receiving, by a processor of a transaction processing entity, a transaction attempt. The method includes receiving a risk score from a risk strategy decision model, the risk score being determined from a machine learning model. The method includes in response to receiving the risk score, determining, whether the risk score exceeds a threshold indicating the transaction attempt is potentially fraudulent. In response to determining the risk score exceeds the threshold: the method includes determining, whether to approve or decline the transaction attempt; and determining a reason for approving or declining the transaction attempt based on one or more variables contributing to the risk score. The method includes outputting an indication to approve or decline the transaction attempt in response to determining whether to approve or decline the transaction attempt and the reason for approving or declining the transaction attempt.

### TECHNICAL FIELD

This disclosure relates generally to transaction processing. More particularly, this disclosure relates to techniques for reducing failed transactions based on false determinations of fraudulent activity.

### BACKGROUND

A server system may utilize various techniques to determine whether a transaction is fraudulent or potentially fraudulent. Many transactions are rejected based on these determinations. In some cases, transactions may be identified as fraudulent that are in fact not fraudulent.

Fraud risk management for a transaction processing entity is a critical and sophisticated system. In some instances, the fraud risk management can leverage intelligence to generate customized risk decisions for different scenarios. Typically, to achieve high accuracy in the risk decision making process, the transaction processing entity balances loss prevention with frustration to legitimate transactions. The transaction processing entities typically leverage advanced and complex machine learning techniques/algorithms. However, these techniques do not provide any reasoning for rejecting a potentially fraudulent transaction.

As a result, parties to transactions may have a negative user experience in which a legitimate transaction is rejected, but the user has no idea how to remedy the issues. Moreover, the techniques can result in declining of transactions that are legitimate and result in significant losses of customers and revenue. Increased transparency in the fraud risk management systems is desired.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a block diagram illustrating a system for handling potentially fraudulent transactions, according to some embodiments.

FIG. 2 illustrates a flowchart of a method for handling potentially fraudulent transactions, according to some embodiments.

FIG. 3 illustrates a flowchart of a method for handling potentially fraudulent transactions, according to some embodiments.

FIG. 4 illustrates a flowchart of a method for handling potentially fraudulent transactions, according to some embodiments.

FIG. 5 shows a decision tree, according to some embodiments.

FIG. 6 shows a decision tree, according to some embodiments.

FIG. 7 illustrates an explainable artificial intelligence (XAI) architecture, according to some embodiments.

FIG. 8 is a flowchart of a method for updating the strategy used in an XAI architecture, according to some embodiments.

FIG. 9 is a block diagram illustrating an internal architecture of an example of a computer, according to some embodiments.

Like reference numbers represent the same or similar parts throughout.

### DETAILED DESCRIPTION

Fraud risk management for a transaction processing entity is a critical and sophisticated system. In some instances, the fraud risk management can leverage intelligence to generate customized risk decisions for different scenarios. Typically, to achieve high accuracy in the risk decision making process, the transaction processing entity balances loss prevention with frustration to legitimate transactions. The transaction processing entities typically leverage advanced and complex machine learning techniques/algorithms. However, these techniques do not provide any reasoning for rejecting a potentially fraudulent transaction.

As a result, parties to transactions may have a negative user experience in which a legitimate transaction is rejected, but the user has no idea how to remedy the issues. Moreover, the techniques can result in declining of transactions that are legitimate and result in significant losses of customers and revenue. Increased transparency in the fraud risk management systems is desired.

In some instances, transaction processing entities may leverage different and complicated risk components (additional risk intelligence such as account level information, financial information, etc.), to generate complex logic to mitigate loss leakages or reduce the false declines. However, it is generally difficult or impossible to identify the reasoning for making the decision. As a result, there is no comprehensive explanation for declines. Instead, the transaction processing entity conducts a thorough and manual case review to understand the exact reasons behind the risk decline.

Explainable Artificial Intelligence (XAI) can be leveraged to identify the reasons for a machine learning model to take particular actions. However, in most machine learning models, there can be thousands of variables contributing to the result. Reviewing thousands of variables contributing to a model score includes many that are not applicable. Moreover, many of the variables themselves are not easily understandable (e.g., it is difficult to understand the meaning of “_blank_CntyBrchRtnbadAcct”).

Embodiments of this disclosure determine the reasons behind a model result (e.g., phone riskiness, suspicious address, etc.). Parties to a transaction (or even the transaction processing entity) can use these reasons to build strategies and make decisions. The embodiments streamline, simplify, and optimize existing risk management processes by leveraging XAI to improve transaction party experience.

Embodiments of this disclosure use an XAI architecture to decrypt an unexplainable model score and reduce the score into several explainable reason groups (even though the fraud model leverages thousands of variables) in plain language for risk decision management. In some embodiments, the risk model is developed based on historical transaction data.

This disclosure relates generally to transaction processing. More particularly, this disclosure relates to techniques for reducing failed transactions based on false determinations of fraudulent activity. In some embodiments of the disclosure, the transaction processing can be payment processing. In some embodiments, a transaction processing entity can leverage an explainable artificial intelligence (XAI) architecture to reduce an impact of false determinations of fraudulent activity. In some embodiments, this can result in an increased number of transactions being approved that would otherwise have been denied as being fraudulent. In some embodiments, the embodiments disclosed can result in an explanation of why a transaction was considered to be fraudulent. In some embodiments, the embodiments disclosed can still reject the transaction as fraudulent. In some embodiments, when a transaction is still rejected, a reason for the rejection can be provided to the party initiating the transaction so that the transaction can be attempted again after resolving the suspected fraudulent activity. In some embodiments, the transaction authenticating party can also be provided with the reason to improve the entity's determination process so that similar transactions can be considered as potentially not fraudulent in the future. In some embodiments, a user experience for the transaction can be improved by reducing frustration with false determinations of fraudulent activity.

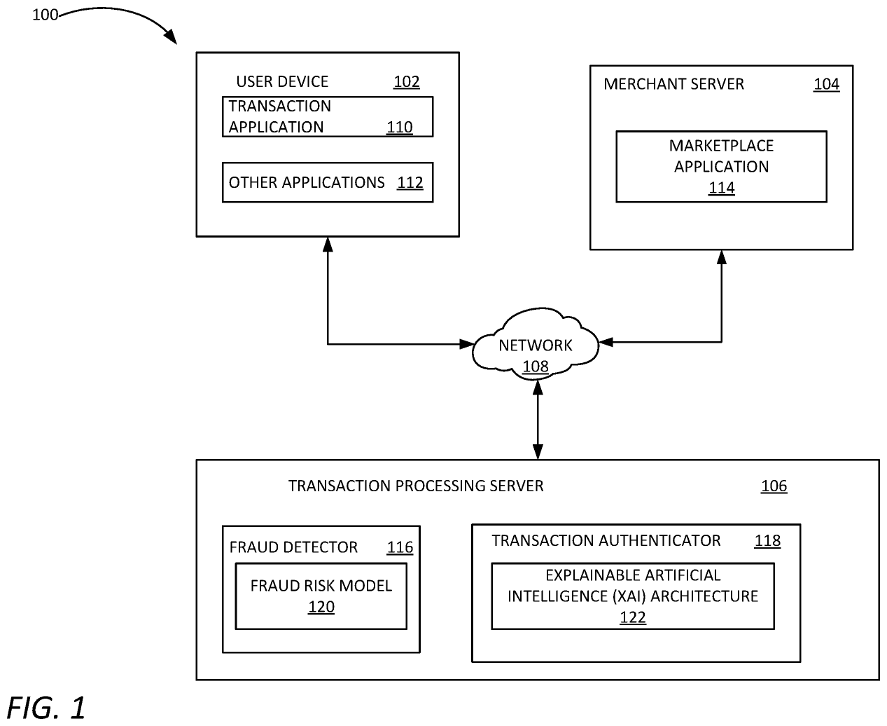

FIG. 1 is a block diagram illustrating a system 100 for handling potentially fraudulent transactions, according to some embodiments. In some embodiments, the system 100 includes a user device 102, a merchant server 104, and a transaction processing server 106 in communication via a network 108.

According to some embodiments, user device 102 can be any type of device such as, but not limited to, a mobile phone, tablet, laptop, sensor, Internet of Things (IoT) device, autonomous machine, and any other device equipped with a cellular or wireless or wired transceiver. In some embodiments, user device 102 can be a device associated with an individual or a set of individuals. In some embodiments, user device 102 includes a transaction application 110 and can include one or more other applications 112.

In some embodiments, the transaction application 110 can be an application configured to execute on the user device 102 that enables a user of the user device 102 to complete a transaction. In some embodiments, the transaction can be, for example, an exchange of money such as a payment transaction or the like. The transaction application 110 can be configured to be executed as a standalone application on the user device 102 or can be a website or other web-based interface through which the user can complete a transaction. In some embodiments, the user device 102 can be used by a user to interact with the merchant server 104 and the transaction processing server 106 over the network 108. For example, a user may use the user device 102 to log in to a user account to conduct electronic transactions (e.g., logins, access content, transfer content, add funding sources, complete account transfers, payments, combinations thereof, or the like) with the transaction processing server 106. In some embodiments, the user device 102 can also interact with the merchant server 104 to, for example, purchase one or more goods, services, or any combination thereof.

In some embodiments, the transaction application 110 can be configured to receive an indication of whether the transaction has been approved or denied from the transaction processing server 106, which can be displayed to the user via a display of the user device 102. In some embodiments, in addition to displaying that the transaction was denied, the transaction application 110 can receive an indication of why the transaction was denied from the transaction processing server 106, which can be displayed on the display of the user device 102 for the user to be able to initiate the transaction attempt again at a later time after the reason for the declining has been remedied. In some embodiments, the transaction may be approved, in which case the transaction application 110 can receive an indication of approval from the transaction processing server 106, which can then be displayed for the user on the display of the user device 102.

In some embodiments, the transaction application 110 can receive a challenge for the user to complete in order to complete the transaction from the transaction processing server 106. For example, if the transaction is determined to be potentially fraudulent by the transaction processing server 106, the user may have to re-enter a password, be presented with a security question, combinations thereof, or the like. Such additional challenges for the user can be displayed by the transaction application 110 on the display of the user device 102.

In some embodiments, the merchant server 104 can be maintained by a business entity (or in some cases, by a partner of a business entity that processes transactions on behalf of business entity). Examples of business entities include merchant sites, resource information sites, utility sites, real estate management sites, social networking sites, or the like, which offer various items for purchase and process payments for the purchases. The merchant server 104 can make various items available to the user device 102 for viewing and purchase by the user.

In some embodiments, the merchant server 104 can include a marketplace application 114, which may be configured to provide information over the network 108 to the transaction application 110 of the user device 102. For example, the user of the user device 102 may interact with the marketplace application 114 through the transaction application 110 over the network 108 to search and view various items available for purchase from the merchant.

The transaction processing server 106 can include a fraud detector 116 and a transaction authenticator 118. In some embodiments, the fraud detector 116 can include a machine learning model 120 (e.g., fraud risk model 120 as shown in FIG. 1) that is utilized to determine whether a transaction is potentially fraudulent. It is to be appreciated that the machine learning model 120 type is not limited. In some embodiments, the fraud detector 116 can include a combination of the machine learning model 120 and a risk strategy for a transaction processing entity.

In some embodiments, a transaction request from the user device 102 (e.g., via the merchant server 104) can be submitted to the fraud detector 116 to determine whether the transaction should be approved or rejected. In some embodiments, the transaction request from the user device 102 is provided to the transaction processing server 106 by the merchant server 104. In some embodiments, based on a risk score, the fraud detector 116 can output an indication of whether to decline or approve the transaction. In some embodiments, the fraud detector 116 can be configured to make the determination of whether to approve or decline the transaction based on a risk score determined from the machine learning model 120. However, the output of fraud detector 116 may not include additional information about why the decision was made.

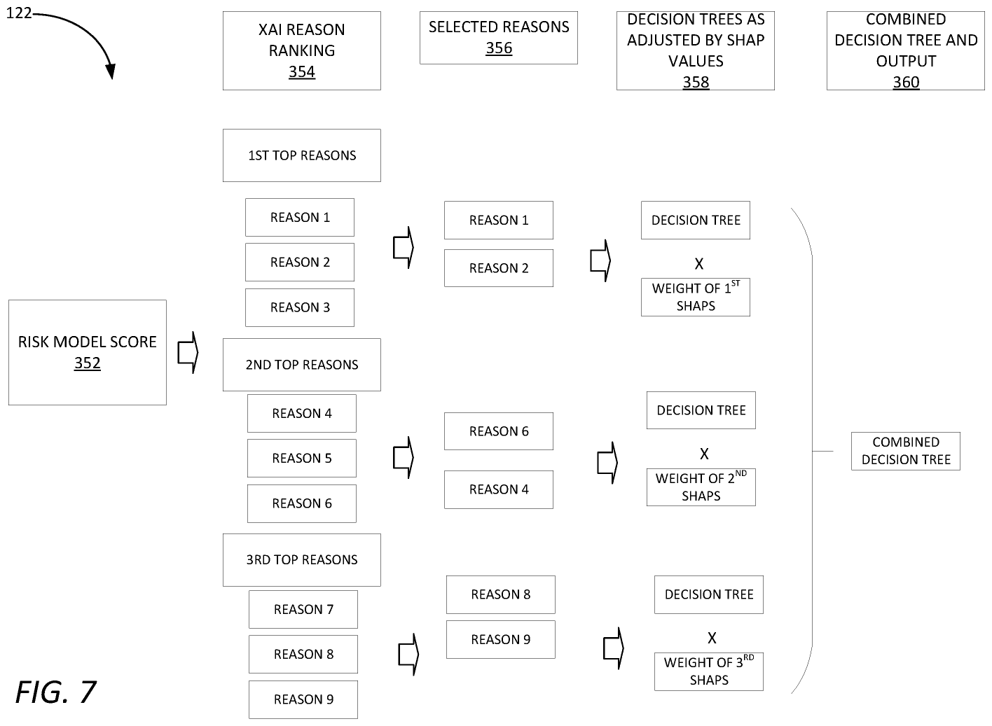

As discussed above, the fraud detector 116 may include the machine learning model 120 for determining whether a transaction is potentially fraudulent. However, machine learning models are generally unable to provide an output indicative of why the transaction may be flagged as potentially fraudulent. As a result, in some embodiments, the fraud detector 116 may not be able to be leveraged to explain to the user why a transaction is potentially fraudulent. Instead, the transaction authenticator 118 including an explainable artificial intelligence (XAI) architecture 122 can be leveraged in combination with the fraud detector 116 to determine why the transaction was potentially fraudulent, and ultimately, whether to approve or decline the transaction. The XAI architecture 122 is shown and described in additional detail in accordance with FIG. 7 below.

In some embodiments, the transaction authenticator 118 can receive a risk score from the fraud detector 116. In some embodiments, the transaction authenticator 118 can use the risk score as an input into the XAI architecture 122. The transaction authenticator 118 can use the XAI architecture 122 to determine reasons that the transaction has been flagged by the fraud detector 116 as being potentially fraudulent. For example, in some embodiments, the transaction authenticator 118 and the XAI architecture 122 can use a Shapley (SHAP) algorithm to generate one or more XAI reasons. In some embodiments, the SHAP algorithm provides an indication of the importance of each variable that contributes to the risk score in fraud detector 116. The one or more XAI reasons can be based on a mapping of the variables from the fraud detector 116 to a defined set of XAI reasons stored in a memory of the transaction processing server 106.

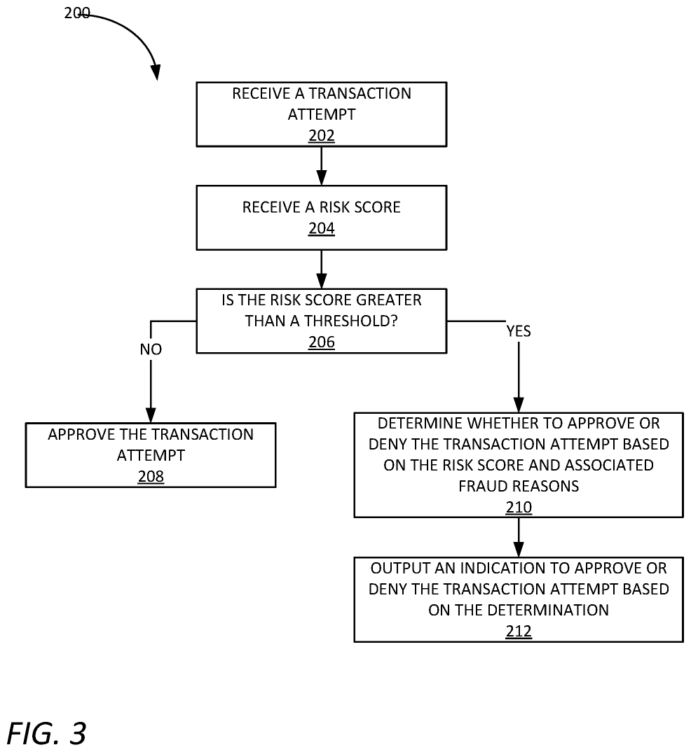

The transaction authenticator 118 can then use the XAI reasons to determine whether to still authorize the transaction, whether to request additional security information from the party to the transaction, or whether to decline the transaction. In some embodiments, a method for using the XAI architecture 122 to make these determinations is described in additional detail in accordance with FIG. 3 below.

In some embodiments, when the transaction authenticator 118 determines to decline a transaction, the reasoning determined by the transaction authenticator 118 can be output to the transaction application 110 so that the user can better understand what happened with the transaction and how to fix and resubmit the transaction if desired.

In some embodiments, the transaction authenticator 118 can make the above determinations based on a risk level of the transaction based on the XAI architecture 122. For example, in some embodiments, the transaction authenticator 118 can classify risk levels into a low risk level, a moderate risk level, or a high risk level. The corresponding actions taken by the transaction authenticator 118 can be based on the risk level.

For example, if the transaction authenticator 118 determines there is a low risk level, the transaction authenticator 118 can approve a transaction even though there is some risk of fraud.

In some embodiments, if the transaction authenticator 118 determines there is a moderate risk level, the transaction authenticator 118 can send a request from the transaction processing server 106 to the transaction application 110 to respond to a challenge. In some embodiments, this can include responding to one or more requests to further confirm the user's identity, such as biometric authentication, confirmation of a phone number or email address, receipt and entry of a unique code, combinations thereof, or the like. The usage of the challenge can be, for example, in a situation where an XAI reason is indicative of a risky user device. As a result, the challenge provided can send a request to a user's known device, and then approve the transaction if the authentication message is passed successfully. It is to be appreciated that this is one example of a challenge. In some embodiments, another example can include, for example, requiring the user to submit an image or other documentation showing proof of the user's ownership of a payment method (e.g., an image of a payment card, or the like).

In some embodiments, if the transaction authenticator 118 determines there is a high risk level, the transaction authenticator 118 can decline the transaction and provide one or more reasons why the transaction was denied to the user via the transaction application 110.

In some embodiments, the network 108 can be implemented as a single network or a combination of multiple networks. In some embodiments, the network 108 may include the Internet, one or more intranets, a landline network, a wireless network, a cellular network, other appropriate types of communication networks, or suitable combinations thereof.

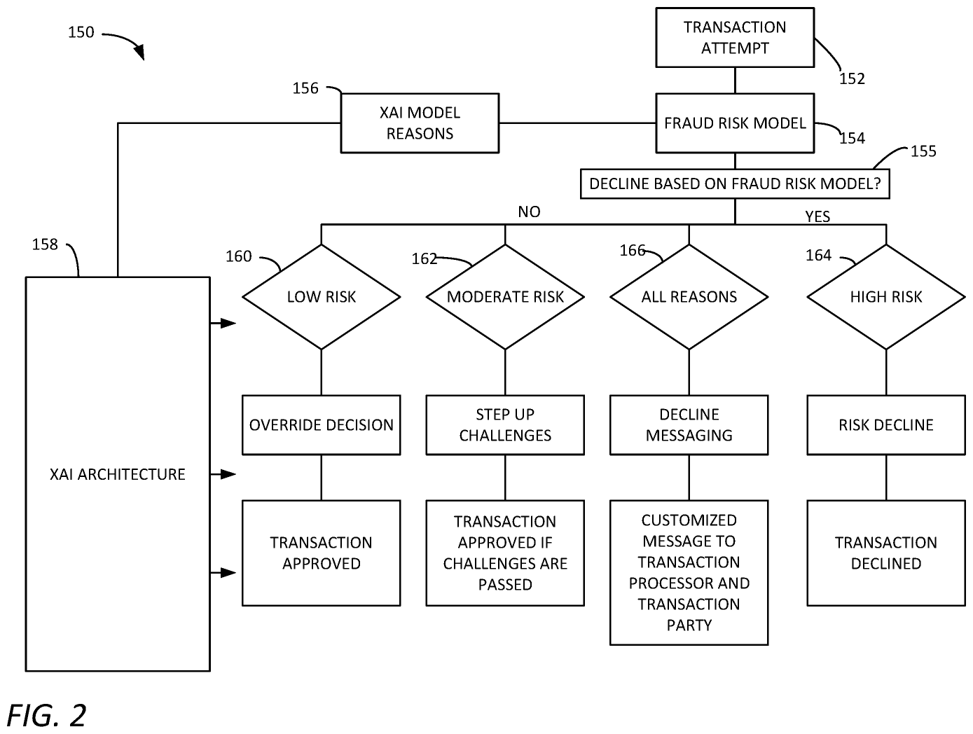

FIG. 2 illustrates a flowchart of a method 150 for handling potentially fraudulent transactions, according to some embodiments. In some embodiments, the method 150 can be performed using the system 100 (FIG. 1) or the like. In some embodiments, the transactions in the method 150 are payment transactions.

At block 152, a transaction attempt is made. For example, a user can attempt to make a payment to another entity via a user device (e.g., user device 102 in FIG. 1). In some embodiments, the entity can be another user device, such as, for example, a merchant (e.g., via a merchant server 104 in FIG. 1), or the like.

At block 154, information from the transaction can be passed into a fraud risk model such as, but not limited to, a machine learning fraud risk model. In some embodiments, the information can be passed via a server (e.g., transaction processing server 106) through a fraud detector (e.g., fraud detector 116 in FIG. 1) containing the fraud risk model (e.g., machine learning model 120 in FIG. 1).

At block 155, the fraud risk model can output an indication of whether the fraud risk model would result in declining the transaction.

At block 156, the fraud detector passes the information to a transaction authenticator (e.g., transaction authenticator 118 in FIG. 1). The transaction authenticator identifies one or more XAI reasons for the riskiness of the transaction based on the output from the fraud risk model.

At block 158, an XAI architecture (e.g., XAI architecture 122) receives the XAI reasons from block 156 and decision making strategy from the XAI architecture to make a determination as to how to handle the transaction.

At block 160, the transaction authenticator can classify risk levels into a low risk level. If there is a low risk level, the transaction authenticator can approve a transaction even though there is some risk of fraud.

At block 162, the transaction authenticator can classify risk levels into a moderate risk level. If there is a moderate risk level, the transaction authenticator can send a request from the transaction processing server to the transaction application (e.g., transaction application 110 in FIG. 1) to respond to a challenge. In some embodiments, this can include responding to one or more requests to further confirm the user's identity, such as biometric authentication, confirmation of a phone number or email address, receipt and entry of a unique code, combinations thereof, or the like. The usage of the challenge can be, for example, in a situation where an XAI reason is indicative of a risky user device. As a result, the challenge provided can send a request to a user's known device, and then approve the transaction if the authentication message is passed successfully. It is to be appreciated that this is one example of a challenge. In some embodiments, another example can include, for example, requiring the user to submit an image or other documentation showing proof of the user's ownership of a payment method (e.g., an image of a payment card, or the like).

At block 164, the transaction authenticator can determine there is a high risk level. If there is a high risk level, the transaction authenticator can decline the transaction and provide one or more reasons why the transaction was denied to the user via the transaction application.

At block 166, the transaction authenticator can, for all risk levels, provide messaging for declining the transaction and presenting to the party of the transaction (and even to the transaction processing entity) reasons for declining the transaction.

FIG. 3 illustrates a flowchart of a method 200 for handling potentially fraudulent transactions, according to some embodiments. In some embodiments, the method 200 can be performed using the system 100 (FIG. 1) or the like.

At block 202, a transaction attempt can be received by a processor of a transaction processing entity. In some embodiments, the transaction can be a payment transaction and the attempt a payment attempt. In some embodiments, the transaction attempt can be received by transaction application 110 (FIG. 1) on user device 102 (FIG. 1). In some embodiments, the transaction attempt can be submitted through an application or website interface on the user device 102 and sent via the network 108 (FIG. 1) to merchant server 104 (FIG. 1) and subsequently via the network 108 to transaction processing server 106 (FIG. 1).

At block 204 a risk score can be received from the processor of the transaction processing entity. In some embodiments, the risk score can be received from fraud detector 116 (FIG. 1). In some embodiments, the risk score can be determined by a fraud detector 116 (FIG. 1). In some embodiments, the risk score can be determined using the machine learning model 120 (FIG. 1). In some embodiments, the risk score can be determined based on a machine learning model in combination with a risk strategy for the transaction processing entity. In some embodiments, inputs to the machine learning model 120 can include, but are not limited to, information about behavior of the transacting parties (e.g., both sending and receiving transacting parties); information about assets of the transacting parties; session data for the current transaction; and payment data for the transaction.

In some embodiments, the risk score may be received by the transaction authenticator 118 (FIG. 1). As discussed regarding FIG. 1, in some embodiments, the risk score may be an output of the fraud detector 116 that is passed to the transaction authenticator 118. In some embodiments, the transaction authenticator 118 can use a fraud risk model configuration (e.g., fraud risk model 120 in FIG. 1) and associated risk score as an input into an explainable artificial intelligence (XAI) architecture.

The transaction authenticator 118 can use the XAI architecture to determine reasons that the transaction has been flagged by the fraud detector 116 as being potentially fraudulent. For example, in some embodiments, the transaction authenticator 118 can use a Shapley (SHAP) algorithm to generate one or more XAI reasons. In some embodiments, the SHAP algorithm provides an indication of the importance of each variable that contributes to the risk score in fraud detector 116. The one or more XAI reasons can be based on a mapping of the variables from the fraud detector 116 to a defined set of XAI reasons stored in a memory of the transaction processing server 106.

The transaction authenticator 118 can then use the XAI reasons to determine whether to still authorize the transaction, whether to request additional security information from the party to the transaction, or whether to decline the transaction.

At block 206, the processor of the transaction processing entity can determine whether the risk score is greater than a threshold. In some embodiments, the determination can be made by the transaction authenticator 118 (FIG. 1). In some embodiments, a threshold value for the risk score can be defined based on one or more prior transactions. In some embodiments, the risk score can be defined based on a risk strategy of the transaction processing entity. For example, in some embodiments, the risk score can be defined based on a scope of the transaction. That is, if the transaction is a payment transaction, the transaction processing entity can set the threshold such that for a transaction less than a particular amount (e.g., $100 as an example), the risk score can be a first threshold. In some embodiments, the impact of accepting a fraudulent transaction may be less if the scope is smaller. In some embodiments, the threshold can be a lower value when the transaction is greater than a particular amount (e.g., greater than $100 as an example). In some embodiments, the risk score can be selected according to the transaction processing entities appetite for accepting risky transactions.

In response to the risk score being lower than the threshold, the transaction can be approved at block 208. That is, at block 208 the transaction authenticator 118 can output an indication to approve the transaction and the transaction can be processed. In some embodiments, an indication of the approval of the transaction can be provided to the party to the transaction via the transaction application 110 and a display of the user device 102.

In response to the risk score exceeding the threshold, the transaction authenticator 118 can utilize the XAI architecture to determine whether to approve or decline the transaction attempt based on the risk score and fraud reasons as determined using the XAI architecture at block 210. The transaction authenticator 118 can be used to both determine whether to approve or decline the transaction and to be able to provide one or more reasons for declining the transaction to the party to the transaction via the transaction application 110 a display of the user device 102.

In response to determining whether to approve or decline the transaction, the transaction authenticator 118 can output an indication to approve the transaction or decline the transaction at block 212.

In some embodiments, if the transaction is approved, no reasons for the approval are provided with the output.

In some embodiments, if the transaction is denied, reasons for the transaction being denied are included with the output. As a result, the user may better understand what went wrong with the transaction attempt.

In some embodiments, the declining and the reasons for the declining can be provided to a party within the transaction processing entity to be able to provide additional assistance to the parties to the transaction.

For example, a party within the transaction processing entity such as customer service or the like can be provided with a report including that the transaction was denied and the fraud reasons that were determined to be indicative of a fraudulent transaction (e.g., a change in the party's shipping address, an unrecognized IP address involved in the transaction, multiple failed transactions, combinations thereof, or the like). In some embodiments, this may enable the transaction processing entity to flag fraudulent users (e.g., due to successive failed transactions, because of a particular suspicious IP address, combinations thereof, or the like), to assist user's with resubmitting the transaction (e.g., instructing the user to confirm the shipping address was intentional, etc.), combinations thereof, or the like.

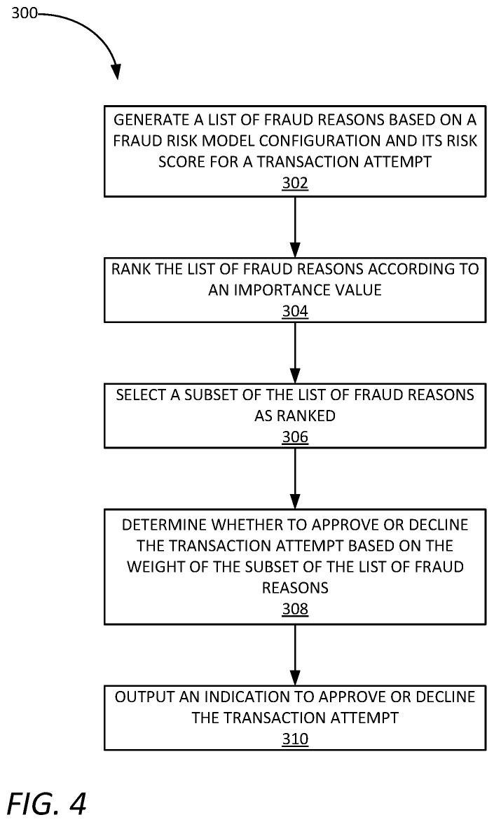

FIG. 4 illustrates a flowchart of a method 300 for handling potentially fraudulent transactions, according to some embodiments. The method 300 can be used to determine whether to approve or decline a transaction attempt at block 210 (FIG. 3), according to some embodiments.

At block 302, the transaction authenticator 118 (FIG. 1) can generate a list of fraud reasons (e.g., XAI reasons) based on a fraud risk model configuration and its risk score received (e.g., from fraud detector 116 in FIG. 1) in a transaction attempt. In some embodiments, the list of fraud reasons can be generated based on an XAI application to the risk score to determine an importance of each variable that contributes to the risk score. In some embodiments, this can include application of a Shapley (SHAP) algorithm to the risk detection model from the fraud detector 116.

In some embodiments, the SHAP algorithm provides an indication of the importance of each variable that contributes to the risk score in fraud detector 116. The one or more XAI reasons can be based on a mapping of the variables from the fraud detector 116 to a defined set of XAI reasons stored in a memory of the transaction processing server 106. The SHAP value of each variable contributing to the risk score in the fraud detector 116 can then be aggregated into a plurality of groupings of fraud reasons.

Examples described herein rely on the SHAP algorithm. It is to be appreciated that other techniques may be possible within the scope of the present disclosure. For example, instead of the SHAP algorithm, it may be possible to use any explainable machine learning techniques that can explain how each feature affects and contributes to the model, such as, but not limited to, breakDown (BD) analysis and Ceteris-Paribus (CP) profiles. The inputs to the SHAP value method include the features used in the machine learning model and also the model output (risk score).

At block 304, the transaction authenticator 118 ranks the list of fraud reasons as generated according to an importance value. The importance value can be based on a likelihood that the reason can explain the riskiness of the transaction, for example. In some embodiments, the importance value can utilize the SHAP value determined at block 302. In some embodiments, the ranking of the list of fraud reasons can be based on a historical understanding of what factors tend to contribute to the riskiness of the transaction. In some embodiments, this can be based on a predefined criteria selected by the transaction processing entity. In some embodiments, the predefined criteria can be based on, for example, a total volume of transactions, a rate of the fraud reason being identified as a fraudulent transaction, an amount of loss possible for the particular transaction, combinations thereof, or the like.

At block 306, the transaction authenticator 118 selects a subset of the list of fraud reasons as ranked at block 304. The subset of the list can be based on identifying a selected number of highest ranked fraud reasons. For example, in some embodiments, at block 306 the top three reasons, top two reasons, or the top reason can be selected from the list of fraud reasons. It is to be appreciated that the above numbers are examples and that the actual number can vary beyond the top three reasons.

Examples of fraud reasons include, but are not limited to, whether the party to the transaction has previously submitted transactions that have failed; that the party is using an unrecognized IP address; a party's shipping address is being used for the first time; the transaction is one of several by the party within a limited period of time; that the party's profile was recently changed; an amount of the transaction is abnormal; combinations thereof, or the like.

At block 308, the transaction authenticator 118 determines whether to approve or decline the transaction attempt based on a weighting of the subset of the list of fraud reasons. In some embodiments, the fraud reasons are combined to provide a collective value. For example, within the subset of fraud reasons, the reasons can each be weighted according to their potential likelihood to impact whether the transaction is fraudulent or not. In some embodiments, part of block 308 can include requesting the party to the transaction complete one or more challenges that, if failed, result in declining of the transaction, or if successful, approval of the transaction. This can be completed, for example, if the weighted reasons indicate a moderate risk level.

In some embodiments, fraud reasons that can be included in the moderate risk level include, but are not limited to, a change in address, an unrecognized IP address for the party to the transaction, combinations thereof, or the like. For example, if a transaction is being processed and one of the fraud reasons indicates that the transaction request came from an unrecognized IP address, the transaction authenticator 118 could cause a challenge to be presented to the party to the transaction on the user device 102 via which the party can, for example, re-enter the party's password or the like. If successful, the transaction authenticator 118 can indicate that the transaction should be approved. If unsuccessful, the transaction authenticator 118 can indicate the transaction should be denied in view of the unrecognized IP address and the failure to properly enter the password.

If the combined weighted reasons are indicative of a low risk level, the transaction can be approved. In some embodiments, a low risk level can include, but is not limited to, a new shipping address or the like.

If the combined weighted reasons are indicative of a high risk level, the transaction can be denied. In some embodiments, a high risk level can include, but is not limited to, an indication of multiple transactions having failed and submitted by the same party; a suspicious amount for the transaction; multiple transactions in a limited time period; combinations thereof, or the like.

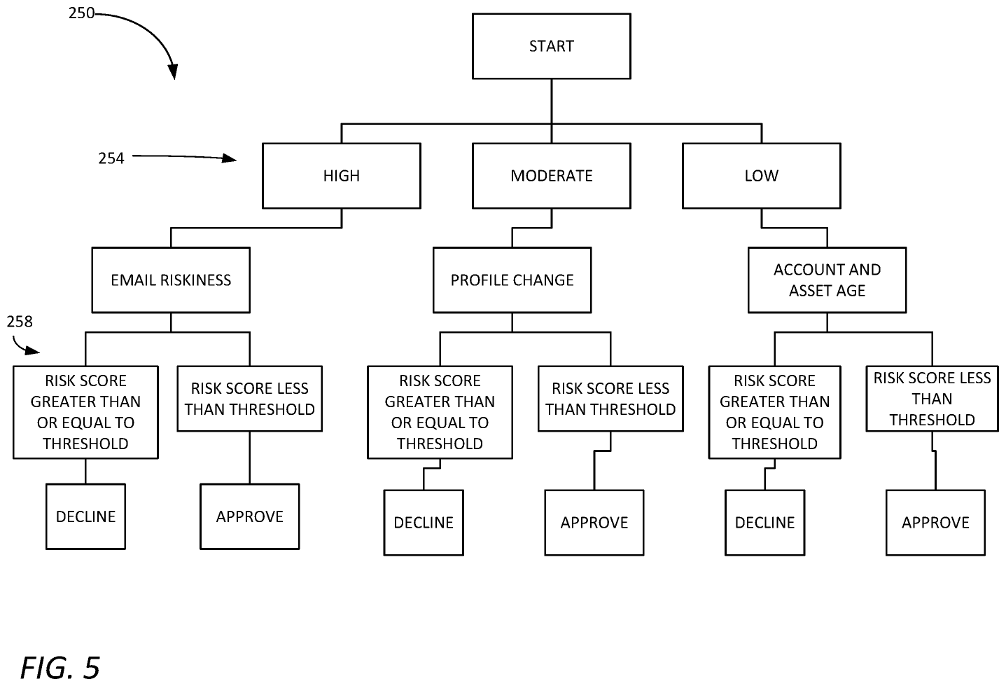

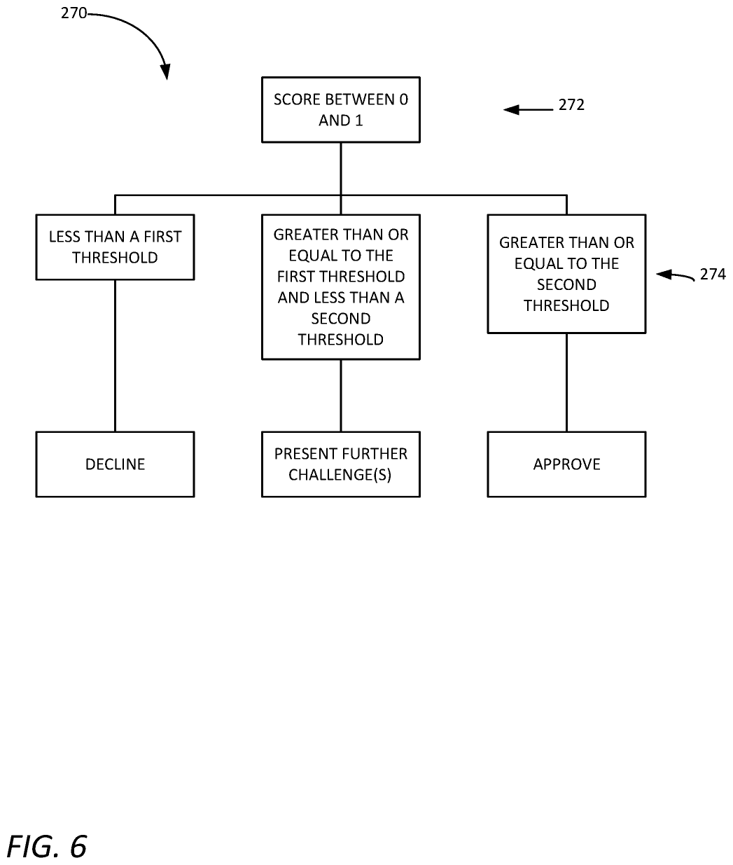

In some embodiments, at block 308, the transaction authenticator 118 determines whether to approve or decline the transaction attempt by generating a decision tree based on the fraud reasons and to determine whether the transaction is considered as risky or not. Example decision trees are shown and described in accordance with FIG. 5 and FIG. 6 below.

With reference to FIG. 5, in some embodiments, the decision tree 250 can be built based on a risk strategy for the transaction processing entity. In some embodiments, the decision tree 250 can include an approve/decline decision or can lead to further decisions within the decision tree 250. For example, the decision tree 250 can include first assessing whether there are any high risk level reasons present at 254, then evaluating the high risk level reasons at 258. In some embodiments, after considering whether the high risk level reasons are present, the decision tree 250 can include evaluating whether intermediate risk level reasons are present at 254. If the intermediate reasons are present, the decision tree 250 can then include providing challenges to the party or parties to the transaction and evaluating the intermediate reasons at 258. If no intermediate reasons are present, the decision tree 250 can include determining whether low risk levels are present at 254. If not, the transaction may be approved. If there are low risk levels present, the decision tree 250 can include determining whether to approve the transaction even though they are present at 258. For example, the transaction authenticator 118 can consider whether there are more than a threshold number of low risk level reasons present. If there are more, the transaction may be approved.

The decision tree 250 can include determinations based on comparison to a threshold value at 258. If the risk model score (e.g., from the machine learning model 120) is greater than or equal to the threshold value, the result may be declining the transaction. Conversely, if the risk model score is less than the threshold value, the result may be approving the transaction. An output of the decision tree can include an approve or decline determination.

Referring to FIG. 6, in some embodiments, at block 308 (FIG. 4), the transaction authenticator 118 can also determine whether to approve or decline the transaction attempt by combining the sub-decision based on the decision tree 250 and the weight of the subset of the list of fraud reasons into a combined decision tree 270. For example, because there can be more than one fraud reason contributing, in some embodiments, for each fraud reason, the weight of the subset of the list of fraud reasons can be summed and a SHAP value for the subset of the list of fraud reasons can be multiplied by the decision tree result to determine an impact to the decision. In the decision tree 270, a score is identified between 0 and 1 at 272. At 274, a decision is made as to whether (1) the score is less than a first threshold, in which case the transaction is declined; (2) the score is greater than or equal to the first threshold and less than a second threshold, in which case further challenges are presented; or (3) the score is greater than or equal to the second threshold, in which case the transaction is approved. In some embodiments, the first threshold can be set at 0.4 and the second threshold can be set at 0.6. It is to be appreciated these values are examples and the thresholds can be modified within the scope of this disclosure.

Prior risk solutions leverage simple decision trees based on several reasons and suffer from some instability such as high bias/variance which means they cannot fully maximize the benefits and the models have some errors. The combined SHAP weighted decision tree 270 improves the performance by encompassing all the contributing reasons and improving the average performance by reducing the mixed reason and inaccurate reason bias through combining all the top contributing reasons selected via SHAP. Adding SHAP weights also reduces the variance introduced by lower weight reasons. High variance comes with high complexity of the decision tree. Adding SHAP weights excludes some error introduced by lower weight reasons as higher SHAP value reasons have the higher differentiation powers.

In some embodiments, the combination of the sub-reasons can improve an overall accuracy of the system 100. For example, there may be multiple reasons mixed together in a single transaction. For example, one transaction can have a high risk score due to both device risk and credit card profile change risk. Thus, taking more top reasons and also their weight into consideration, instead of just using top one reason, can help include more information and explain the decision more comprehensively. Moreover, the SHAP value represents how much the reason contributes to the final risk score. As such, multiplying weights can improve an accuracy of the final result and eliminate bias toward one of the reasons. For example, if the top 1 and top 2 reason have very similar SHAP values, they can be treated equally instead of one being determinative. In some embodiments, a final score can be calculated using the following formulas:

$$Weight for Tier 1 = SHAP 1 / SUM ( ALL SHAPS ) )$$

Final score=Decision Tree1 result (1 or 0)*1st SHAP weights+Decision Tree2 result (1 or 0)*2nd SHAP weights+ . . . +Decision Tree n result (1 or 0)*Tier n weights

Referring again to FIG. 4, at block 310, the transaction authenticator 118 outputs an indication whether to approve or decline the transaction attempt based on the determining at block 308. In addition to outputting an indication as to whether to approve or decline the transaction attempt, the transaction authenticator 118 can output one or more of the fraud reasons or a message based on the one or more fraud reasons to the user attempting the transaction so the user can retry the transaction attempt after resolving the fraud reasons. In some embodiments, if the fraud reasons were errors, the user can work with the transaction processing entity to resolve the issues.

FIG. 7 illustrates an explainable artificial intelligence (XAI) architecture 122, according to some embodiments. The XAI architecture 122 can be used in the method 300 to determine whether to approve or decline a transaction.

As illustrated, an input to the XAI architecture 122 is a risk model score 352. In some embodiments, the risk model score 352 is from a risk strategy decision model (e.g., machine learning model 120 in FIG. 1) and can be received from the fraud detector 116 by the transaction authenticator 118. In some embodiments, by leveraging XAI architecture 122, a list of fraud reasons 354 can be generated to explain each payment attempt's risk model score 352, and why it is high or low. For example, in some embodiments, the transaction authenticator 118 (FIG. 1) can use a Shapley (SHAP) algorithm to generate one or more XAI reasons. In some embodiments, the SHAP algorithm provides an indication of the importance of each variable that contributes to the risk score in fraud detector 116. The one or more XAI reasons can be based on a mapping of the variables from the fraud detector 116 to a defined set of XAI reasons stored in a memory of the transaction processing server 106.

The fraud reasons 354 can be ranked according to a value such as, but not limited to, the SHAP value or the like. For example, the fraud reasons 354 can include a “New or Suspicious Shipping Address” and a “High Risk Item.” In such embodiments, the SHAP value for each reason can be 0.0024 and 0.00932, respectively. These values are examples and can vary beyond the stated values. The SHAP value is a numeric representation of a likelihood the reason has in explaining the risk score. Accordingly, in the example numbers, the potential for the transaction being fraudulent in the example can have a higher likelihood due to the “New or Suspicious Shipping Address” than due to being a “High Risk Item.”

In some embodiments, the fraud reasons can be grouped. For example, there can be a plurality of top reasons collected in different tiers included in the fraud reasons 354. For example, a reason in a first tier can include “New or Suspicious Shipping Address,” and a second tier can include a “Profile Credit Card Change.” It is to be appreciated that these are examples and can vary beyond the stated examples. In some embodiments, tiers can be defined according to the SHAP value of all the reasons. For example, if there are 35 reason codes in total for all transactions, and for a specific transaction (transaction A), all 35 reason codes have their own SHAP value, ranking from largest to smallest. In some embodiments, the top five reason codes with the highest SHAP value can be selected as the top 5 tier. The number of selected reason codes is not fixed. In some embodiments, a number of tiers can vary. In some embodiments, by combining each transaction's tier 1, 2, . . . , 5, the reason codes can be distributed for all transactions. Then, in some embodiments, some reason codes in each transaction can be selected and grouped. For example, in some embodiments, if the top 1 reason code (tier 1 reason) for only a few transactions is “Multiple attempts failure,” the code can be grouped as “moderate risk.” However, when it comes to the tier 5, many of the transactions have the top 5 reason as “Multiple attempts failure,” which might be grouped as “low risk” in tier 5.

In some embodiments, the top ranked reasons can then be selected to create a listing of selected reasons 356. In some embodiments, the number of selected reasons 356 can be predetermined to include the top one, top two, top three, etc. reasons. The selected reasons 356 can be narrowed based on criteria including a magnitude of the issue (e.g., a single transaction, multiple transactions), a total scope of the transaction (e.g., an amount involved), an overall riskiness of the reason (e.g., historical indication that the reason is likely involved with fraudulent transactions), a potential for loss (e.g., based on the transaction amount or volume of goods or services involved in the transaction), combinations thereof, or the like. The selected reasons 356 can be used to build a decision tree 358 to generate a sub-decision tree to get initial decision. An output considering the different levels and combined weightings 360 of selected reason codes can then be ensembled and used to output a determination whether to approve or decline the transaction attempt. The output can include the selected reasons 356 so that a user can determine how to resolve the concerns if the transaction is denied based on the selected reasons 356.

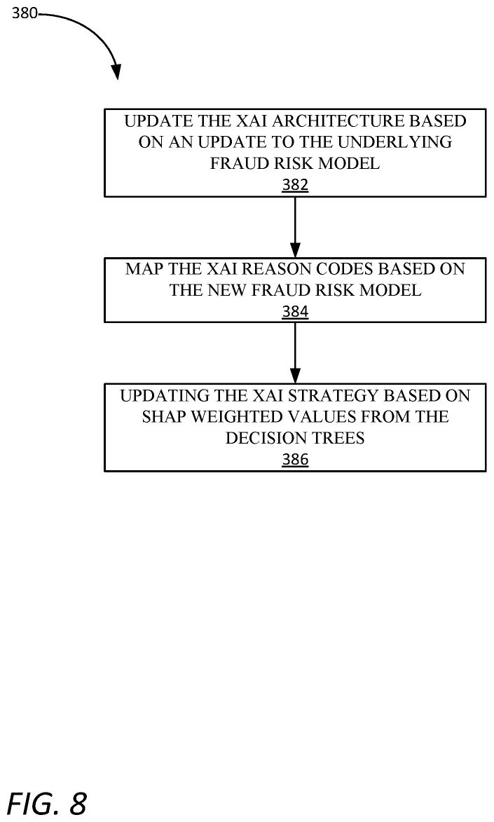

FIG. 8 is a flowchart of a method 380 for updating the strategy used in an XAI architecture (e.g., the XAI architecture 122 in FIG. 1), according to some embodiments. In some embodiments, the fraud risk model to catch fraud patterns changes over time and accordingly the XAI architecture also needs to be refreshed to understand the fraud risk model changes. The method 380 refreshes the model automatically and quickly to incorporate latest data patterns in order to maintain high level performances. The XAI architecture is paired with a refresh of the fraud risk model to explain the refreshed model learning result and to improve model decision transparency. Riskiness of XAI reason changes over time and XAI strategy performance can also deteriorate and needs to be refreshed.

At block 382, the method 380 includes updating the XAI architecture based on an update to the underlying fraud risk model. In some embodiments, this can include updating the XAI architecture to include corresponding variables and features used in the updated fraud risk model, providing risk model output scores, and historical data of payments. At block 382, one or more XAI reasons can be added to the XAI architecture; one or more XAI reasons can be removed from the XAI architecture; or both one or more XAI reasons can be added to the XAI architecture and one or more XAI reasons can be removed from the XAI architecture. The reasons are modified based on the changing fraud risk model.

At block 384, the method 380 includes mapping the XAI reason codes based on the new fraud risk model. The mapping includes aligning the new XAI reason codes to the corresponding component of the risk model that was modified.

At block 386, the method 380 includes updating the XAI strategy based on SHAP weighted values from the decision trees (e.g., decision tree 250 or 270). The decision tree is used to update the XAI architecture for the corresponding transactions. The updated decision tree relies upon the mapping of the XAI reason codes at block 384.

In some embodiments, the method 380 can additionally include one or more steps of monitoring the performance of the updated XAI architecture to ensure that the refresh is appropriately tracking the changes to the fraud risk model.

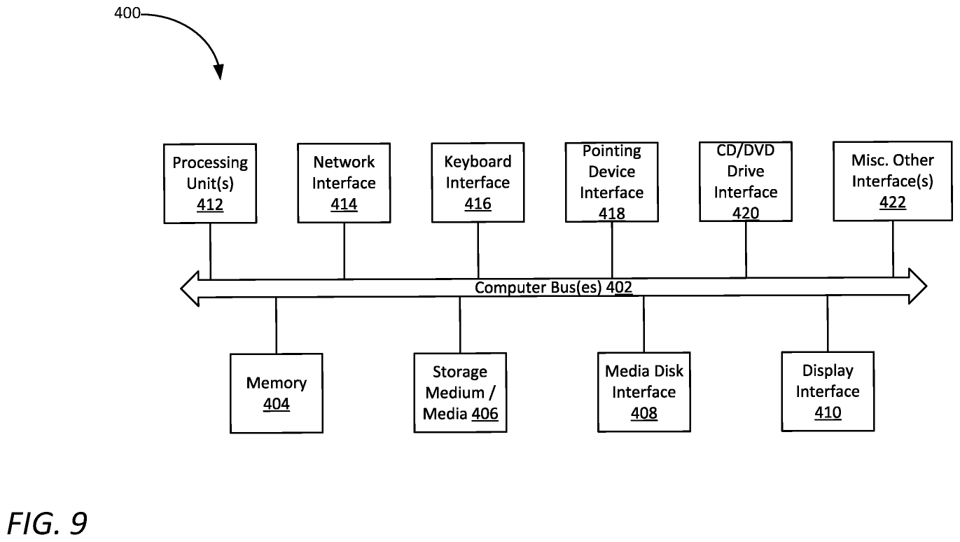

FIG. 9 is a block diagram illustrating an internal architecture 400 of an example of a computer, such as the user device 102 (FIG. 1), the merchant server 104 (FIG. 1), or the transaction processing server 106 (FIG. 1), according to some embodiments. A computer device as referred to herein refers to any device with a processor capable of executing logic or coded instructions, and could be a server, personal computer, set top box, smart phone, pad computer or media device, to name a few such devices. As shown in the example of FIG. 9, internal architecture 400 includes one or more processing units (also referred to herein as CPUs 412), which interface with at least one computer bus 402. Also interfacing with computer bus 402 are persistent storage medium/media 406, network interface 414, memory 404, e.g., random access memory (RAM), run-time transient memory, read only memory (ROM), etc., media disk drive interface 408 as an interface for a drive that can read and/or write to media including removable media such as floppy, CD ROM, DVD, etc. media, display interface 410 as interface for a monitor or other display device, keyboard interface 416 as interface for a keyboard, pointing device interface 418 as an interface for a mouse or other pointing device, CD/DVD drive interface 420, and miscellaneous other interfaces 422 not shown individually, such as parallel and serial port interfaces, a universal serial bus (USB) interface, and the like.

Memory 404 interfaces with computer bus 402 so as to provide information stored in memory 404 to CPU 412 during execution of software programs such as an operating system, application programs, device drivers, and software modules that comprise program code, and/or computer executable process operations, incorporating functionality described herein, e.g., one or more of process flows described herein. CPU 412 first loads computer executable process operations from storage, e.g., memory 404, storage medium/media 406, removable media drive, and/or other storage device. CPU 412 can then execute the stored process operations in order to execute the loaded computer-executable process operations. Stored data, e.g., data stored by a storage device, can be accessed by CPU 412 during the execution of computer-executable process operations.

In some embodiments, the fraud detector 116, the transaction authenticator 118, or both the fraud detector 116 and the transaction authenticator 118 can, for example, be stored in the memory 404 of the internal architecture 400 such that the CPU 412 is configured to perform the functions of the methods described in detail above.

Persistent storage medium/media 406 is a computer readable storage medium(s) that can be used to store software and data, e.g., an operating system and one or more application programs. Persistent storage medium/media 406 can also be used to store device drivers, such as one or more of a digital camera driver, monitor driver, printer driver, scanner driver, or other device drivers, web pages, content files, playlists and other files. Persistent storage medium/media 406 can further include program modules and data files used to implement one or more embodiments of the present disclosure.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Examples of non-transitory computer-readable storage media include, but are not limited to, any tangible medium capable of storing a computer program for use by a programmable processing device to perform functions described herein by operating on input data and generating an output. A computer program is a set of instructions that can be used, directly or indirectly, in a computer system to perform a certain function or determine a certain result. Examples of non-transitory computer-readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to convey the substance of their work most effectively to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

In some embodiments, a computer-implemented method, including: receiving, by a processor of a transaction processing entity, a transaction attempt; receiving, by the processor of the transaction processing entity, a risk score from a risk strategy decision model, wherein the risk score is determined from a machine learning model; in response to receiving the risk score, determining, by the processor of the transaction processing entity, whether the risk score exceeds a threshold indicating the transaction attempt is potentially fraudulent; in response to determining the risk score exceeds the threshold: determining, by the processor of the transaction processing entity, whether to approve or decline the transaction attempt; and determining, by the processor of the transaction processing entity, a reason for approving or declining the transaction attempt based on one or more variables contributing to the risk score; outputting, by the processor of the transaction processing entity, an indication to approve or decline the transaction attempt in response to the determining whether to approve or decline the transaction attempt; and outputting, by the processor of the transaction processing entity, the reason for approving or declining the transaction attempt.

In some embodiments, a computer-implemented method, wherein the determining, by the processor of the transaction processing entity, the reason for approving or declining the transaction attempt, includes: generating, by the processor of the transaction processing entity, a list of fraud reasons based on the risk score, wherein each fraud reason of the list of fraud reasons includes an importance value; ranking, by the processor of the transaction processing entity, the list of fraud reasons according to the importance value; and selecting, by the processor of the transaction processing entity, a subset of the list of fraud reasons as ranked.

In some embodiments, a computer-implemented method, further including determining, by the processor of the transaction processing entity, a weight of the subset of the list of fraud reasons; and generating a decision tree based on the subset of the list of fraud reasons to determine whether a transaction is potentially fraudulent; wherein determining, by the processor of the transaction processing entity, whether to approve or decline the transaction attempt is based on the decision tree and the weight of the subset of the list of fraud reasons.

In some embodiments, a computer-implemented method, wherein determining whether to approve or decline the transaction attempt includes outputting, by the processor of the transaction processing entity, an authentication challenge to a party of the transaction attempt, and wherein in response to the party of the transaction attempt successfully completing the authentication challenge, the computer-implemented method further includes: determining, by the processor of the transaction processing entity, to approve the transaction attempt.

In some embodiments, a computer-implemented method, wherein determining whether to approve or decline the transaction attempt includes outputting, by the processor of the transaction processing entity, an authentication challenge to a party of the transaction attempt, and wherein in response to the party of the transaction attempt failing the authentication challenge, the computer-implemented method further includes: determining, by the processor of the transaction processing entity, to decline the transaction attempt.

In some embodiments, a computer-implemented method, wherein the determining, by the processor of the transaction processing entity, whether to approve or decline the transaction attempt uses an explainable artificial intelligence architecture, wherein the explainable artificial intelligence architecture is used to determine one or more fraud reasons contributing to the risk score and corresponding importance of the one or more fraud reasons in contributing to the risk score, and to determine whether to approve or decline the transaction attempt based on the corresponding importance.

In some embodiments, a computer-implemented method, wherein the determining, by the processor of the transaction processing entity, the reason for approving or declining the transaction attempt uses an explainable artificial intelligence architecture to group one or more variables contributing to the risk score into one or more fraud reasons, the reason for approving or declining the attempt being based on the one or more fraud reasons.

In some embodiments, a computer-implemented method, wherein the determining, by the processor of the transaction processing entity, the reason for approving or declining the transaction attempt, includes: generating, by the processor of the transaction processing entity, a list of fraud reasons based on the risk score and reasons contributing to the risk score.

In some embodiments, a computer-implemented method, wherein a list of fraud reasons is determined based on the risk score, and wherein each fraud reason of the list of fraud reasons includes a risk level indicating a low risk level, a moderate risk level, or a high risk level; and wherein in response to a subset of fraud reasons including the high risk level, further including: outputting, by the processor of the transaction processing entity, the indication to decline the transaction attempt.

In some embodiments, a computer-implemented method, wherein a list of fraud reasons is determined based on the risk score, and wherein each fraud reason of the list of fraud reasons includes a risk level indicating a low risk level, a moderate risk level, or a high risk level; and wherein in response to a subset of fraud reasons including the low risk level, further including: outputting, by the processor of the transaction processing entity, the indication to approve the transaction attempt.

In some embodiments, a computer-implemented method, wherein a list of fraud reasons is determined based on the risk score, and wherein each fraud reason of the list of fraud reasons includes a risk level indicating a low risk level, a moderate risk level, or a high risk level; and wherein in response to a subset of fraud reasons including the moderate risk level, further including: outputting, by the processor of the transaction processing entity, an authentication challenge to a party of the transaction attempt.

In some embodiments, a non-transitory computer-readable medium having instructions stored thereon that are executable by a computing device to perform operations including: determining, by a transaction authenticator, whether a risk score associated with a transaction attempt exceeds a threshold indicating the transaction attempt is potentially fraudulent; in response to determining the risk score exceeds the threshold: generating, by the transaction authenticator, a list of fraud reasons based on the risk score, wherein each fraud reason of the list of fraud reasons includes an importance value; determining, by the transaction authenticator, a weight of a subset of the list of fraud reasons; generating, by the transaction authenticator, a decision tree based on the subset of the list of fraud reasons to determine whether a transaction is potentially fraudulent; determining, by the transaction authenticator, whether to approve or decline the transaction attempt based on the decision tree and the weight of the subset of list of fraud reasons; and outputting, by the transaction authenticator, an indication to approve or decline the transaction attempt in response to the determining whether to approve or decline the transaction attempt.

In some embodiments, a non-transitory computer readable medium, further including ranking, by the transaction authenticator, the list of fraud reasons according to the importance value; and selecting, by the transaction authenticator, the subset of the list of fraud reasons as ranked.

In some embodiments, a non-transitory computer readable medium, wherein in response to the subset of fraud reasons including a high risk level, further including: outputting, by the transaction authenticator, the indication to decline the transaction attempt.

In some embodiments, a non-transitory computer readable medium, wherein in response to the subset of fraud reasons including a low risk level, further including: outputting, by the transaction authenticator, the indication to approve the transaction attempt.

In some embodiments, a non-transitory computer readable medium, wherein in response to the subset of fraud reasons including a moderate risk level, further including: outputting, by the transaction authenticator, an authentication challenge to a party of the transaction attempt.

In some embodiments, a computer-implemented method, including: determining, by a processor of a transaction processing entity, whether a risk score associated with a transaction attempt exceeds a threshold indicating the transaction attempt is potentially fraudulent; in response to determining the risk score exceeds the threshold: determining, by the processor of the transaction processing entity, whether to approve or decline the transaction attempt; and determining, by the processor of the transaction processing entity, a reason for approving or declining the transaction attempt using an explainable artificial intelligence (XAI) architecture; outputting, by the processor of the transaction processing entity, an indication to approve or decline the transaction attempt in response to the determining whether to approve or decline the transaction attempt; and outputting, by the processor of the transaction processing entity, the reason for approving or declining the transaction attempt.

In some embodiments, a computer-implemented method, wherein determining, by the processor of the transaction processing entity, the reason for approving or declining the transaction attempt further includes: generating, by the processor of the transaction processing entity, a list of fraud reasons based on the risk score, wherein each fraud reason of the list of fraud reasons includes an importance value; ranking, by the processor of the transaction processing entity, the list of fraud reasons according to the importance value; and selecting, by the processor of the transaction processing entity, a subset of the list of fraud reasons as ranked.

In some embodiments, a computer-implemented method, wherein the determining, by the processor of the transaction processing entity, whether to approve or decline the transaction attempt uses an explainable artificial intelligence architecture.

In some embodiments, a computer-implemented method, determining, by the processor of the transaction processing entity, whether to approve or decline the transaction attempt further including: outputting, by the processor of the transaction processing entity, an authentication challenge to a party of the transaction attempt; and in response to the party of the transaction attempt failing the authentication challenge: outputting, by the processor of the transaction processing entity, the indication to decline the transaction attempt.

In some embodiments, a computer-implemented method, updating the XAI architecture based on an update to an underlying fraud risk model used to determine the risk score.

1. A computer-implemented method, comprising:
receiving, by a processor of a transaction processing entity, a transaction attempt;
receiving, by the processor of the transaction processing entity, a risk score from a risk strategy decision model, wherein the risk score is determined from a machine learning model;
in response to receiving the risk score:
determining, by the processor of the transaction processing entity, whether the risk score exceeds a threshold indicating the transaction attempt is potentially fraudulent;
in response to determining the risk score exceeds the threshold:
determining, by the processor of the transaction processing entity, whether to approve or decline the transaction attempt; and
determining, by the processor of the transaction processing entity, a reason for approving or declining the transaction attempt based on one or more variables contributing to the risk score;
outputting, by the processor of the transaction processing entity, an indication to approve or decline the transaction attempt in response to the determining whether to approve or decline the transaction attempt; and
outputting, by the processor of the transaction processing entity, the reason for approving or declining the transaction attempt.

2. The computer-implemented method of claim 1, wherein the determining, by the processor of the transaction processing entity, the reason for approving or declining the transaction attempt, comprises:
generating, by the processor of the transaction processing entity, a list of fraud reasons based on the risk score,
wherein each fraud reason of the list of fraud reasons includes an importance value;
ranking, by the processor of the transaction processing entity, the list of fraud reasons according to the importance value; and
selecting, by the processor of the transaction processing entity, a subset of the list of fraud reasons as ranked.

3. The computer-implemented method of claim 2, further comprising determining, by the processor of the transaction processing entity, a weight of the subset of the list of fraud reasons; and
generating a decision tree based on the subset of the list of fraud reasons to determine whether a transaction is potentially fraudulent;
wherein determining, by the processor of the transaction processing entity, whether to approve or decline the transaction attempt is based on the decision tree and the weight of the subset of the list of fraud reasons.

4. The computer-implemented method of claim 1, wherein the determining, by the processor of the transaction processing entity, the reason for approving or declining the transaction attempt, comprises:
generating, by the processor of the transaction processing entity, a list of fraud reasons based on the risk score and a Shapley (SHAP) algorithm to determine a likelihood each of the list of fraud reasons has in explaining the risk score.

5. The computer-implemented method of claim 1, wherein determining whether to approve or decline the transaction attempt comprises outputting, by the processor of the transaction processing entity, an authentication challenge to a party of the transaction attempt, and wherein in response to the party of the transaction attempt successfully completing the authentication challenge, the computer-implemented method further comprises:
determining, by the processor of the transaction processing entity, to approve the transaction attempt.

6. The computer-implemented method of claim 1, wherein determining whether to approve or decline the transaction attempt comprises outputting, by the processor of the transaction processing entity, an authentication challenge to a party of the transaction attempt, and wherein in response to the party of the transaction attempt failing the authentication challenge, the computer-implemented method further comprises:
determining, by the processor of the transaction processing entity, to decline the transaction attempt.

7. The computer-implemented method of claim 1, wherein the determining, by the processor of the transaction processing entity, whether to approve or decline the transaction attempt uses an explainable artificial intelligence architecture, wherein the explainable artificial intelligence architecture is used to determine one or more fraud reasons contributing to the risk score and corresponding importance of the one or more fraud reasons in contributing to the risk score, and to determine whether to approve or decline the transaction attempt based on the corresponding importance.

8. The computer-implemented method of claim 1, wherein the determining, by the processor of the transaction processing entity, the reason for approving or declining the transaction attempt uses an explainable artificial intelligence architecture to group one or more variables contributing to the risk score into one or more fraud reasons, the reason for approving or declining the attempt being based on the one or more fraud reasons.

9. The computer-implemented method of claim 1, wherein the determining, by the processor of the transaction processing entity, the reason for approving or declining the transaction attempt, comprises:
generating, by the processor of the transaction processing entity, a list of fraud reasons based on the risk score and reasons contributing to the risk score.

10. The computer-implemented method of claim 1, wherein a list of fraud reasons is determined based on the risk score, and wherein each fraud reason of the list of fraud reasons includes a risk level indicating a low risk level, a moderate risk level, or a high risk level; and
wherein in response to a subset of fraud reasons including the high risk level, further comprising:
outputting, by the processor of the transaction processing entity, the indication to decline the transaction attempt.

11. The computer-implemented method of claim 1, wherein a list of fraud reasons is determined based on the risk score, and wherein each fraud reason of the list of fraud reasons includes a risk level indicating a low risk level, a moderate risk level, or a high risk level; and
wherein in response to a subset of fraud reasons including the low risk level, further comprising:
outputting, by the processor of the transaction processing entity, the indication to approve the transaction attempt.

12. The computer-implemented method of claim 1, wherein a list of fraud reasons is determined based on the risk score, and wherein each fraud reason of the list of fraud reasons includes a risk level indicating a low risk level, a moderate risk level, or a high risk level; and
wherein in response to a subset of fraud reasons including the moderate risk level, further comprising:
outputting, by the processor of the transaction processing entity, an authentication challenge to a party of the transaction attempt.

13. A non-transitory computer-readable medium having instructions stored thereon that are executable by a computing device to perform operations comprising:
determining, by a transaction authenticator, whether a risk score associated with a transaction attempt exceeds a threshold indicating the transaction attempt is potentially fraudulent;
in response to determining the risk score exceeds the threshold:
generating, by the transaction authenticator, a list of fraud reasons based on the risk score,
wherein each fraud reason of the list of fraud reasons includes an importance value;
determining, by the transaction authenticator, a weight of a subset of the list of fraud reasons;
generating, by the transaction authenticator, a decision tree based on the subset of the list of fraud reasons to determine whether a transaction is potentially fraudulent;
determining, by the transaction authenticator, whether to approve or decline the transaction attempt based on the decision tree and the weight of the subset of list of fraud reasons; and
outputting, by the transaction authenticator, an indication to approve or decline the transaction attempt in response to the determining whether to approve or decline the transaction attempt.

14. The non-transitory computer readable medium of claim 13, further comprising ranking, by the transaction authenticator, the list of fraud reasons according to the importance value; and
selecting, by the transaction authenticator, the subset of the list of fraud reasons as ranked.

15. The non-transitory computer readable medium of claim 13, wherein in response to the subset of fraud reasons including a high risk level, further comprising:
outputting, by the transaction authenticator, the indication to decline the transaction attempt.

16. The non-transitory computer readable medium of claim 13, wherein in response to the subset of fraud reasons including a low risk level, further comprising:
outputting, by the transaction authenticator, the indication to approve the transaction attempt.

17. The non-transitory computer readable medium of claim 13, wherein in response to the subset of fraud reasons including a moderate risk level, further comprising:
outputting, by the transaction authenticator, an authentication challenge to a party of the transaction attempt.

18. A system, comprising:
a processor, wherein the processor is configured to:
determine whether a risk score associated with a transaction attempt exceeds a threshold indicating the transaction attempt is potentially fraudulent;
in response to determining the risk score exceeds the threshold:
determine whether to approve or decline the transaction attempt; and
determine a reason for approving or declining the transaction attempt using an explainable artificial intelligence (XAI) architecture;
output an indication to approve or decline the transaction attempt in response to the determining whether to approve or decline the transaction attempt; and
output the reason for approving or declining the transaction attempt.

19. The system of claim 18, wherein the determining the reason for approving or declining the transaction attempt further comprises:
the processor configured to:
generate a list of fraud reasons based on the risk score,
wherein each fraud reason of the list of fraud reasons includes an importance value;
rank the list of fraud reasons according to the importance value; and
select a subset of the list of fraud reasons as ranked.

20. The system of claim 18, wherein the processor is further configured to update the XAI architecture based on an update to an underlying fraud risk model used to determine the risk score.
